(19) United States
(12) Patent Application Publication
(10) Pub. No.: US 2010/0275868 A1
(43) Pub. Date: Nov. 4, 2010

(54) LASER MODULE

(76) Inventors: Werner Herden, Gerlingen (DE); Martin Weinrotter, Stuttgart-Botnang (DE); Paseal Woerner, Stuttgart (DE); Juergen Raimann, Weil Der Stadt (DE)

Correspondence Address: KENYON & KENYON LLP, ONE BROADWAY, NEW YORK, NY, 10004, US

(21) Appl. No.: 12/734,052

(22) PCT Filed: Sep. 12, 2008
(86) PCT No.: PCT/EP2008/062171

§ 371 Date: Jul. 9, 2010

(30) Foreign Application Priority Data
Oct. 10, 2007 (DE) 10 2007 048 617.2

(51) Int. Cl. F02B 19/00

(52) U.S. Cl. 123/143 B

(57) ABSTRACT

A laser module includes a housing and at least one laser device situated in the housing for generating laser pulses. The laser module has at least one primary sealing region and a secondary sealing region that is situated at least partially in the primary sealing region, and the laser device is situated within the secondary sealing region.

### BACKGROUND OF THE INVENTION

1. Field of Invention

The present invention relates to a laser module having a housing and having at least one laser device, for generating laser pulses, situated in the housing.

2. Description of Related Art

Such laser modules are known, and the laser device integrated into them has, for example, a Q-switched solid laser which generates laser pulses when acted upon by pumping light.

The high radiation intensities of the laser radiation that occur during the operation of such a laser module favor the fouling of the optical surfaces of the laser device by an effect also designated as “laser-assisted deposition”, as a result of which particles located in the housing, that are undesired per se, deposit preferably on surfaces that are acted upon by high radiation intensities, because the particles are attracted by these surfaces in a special way. In order to keep such contamination of the optical surfaces as low as possible, it is provided for the usual laser modules that one develop the housing of the laser module as tight as possible, and thus to make the penetration of particles more difficult.

A hermetic sealing of the housing, that is aimed at thereby, is, however, very costly, especially in fields of use having higher environmental temperatures or temperature fluctuations and/or other changing environmental conditions, such as environmental pressure, particularly if the housing has one or more optically transparent regions which are provided for coupling out generated laser pulses, for example.

### BRIEF SUMMARY OF THE INVENTION

Accordingly, it is an object of the present invention to improve a laser module of the type mentioned at the outset, to the extent that fouling, and particularly a deterioration of the optical surfaces of the laser device, by particle action or the like, is prevented or reduced, without requiring an expenditure for the hermetic sealing of the housing as in the conventional arrangement.

In the laser module according to the present invention, this object is attained, in that the laser module has at least one primary sealing region, and a secondary sealing region situated at least partially in the primary sealing region, and in that the laser device is situated within the secondary sealing region.

Because of the provision of the two at least partially cascaded sealing regions, according to the present invention, there advantageously comes about an increased sealing effect, compared to the conventional systems, while at the same time increased construction expenditure is avoided.

It was recognized, according to the present invention, that when several at least partially cascaded sealing regions were provided, an improved adjustment of the properties of the sealing regions to the components to be protected is given thereby. While the laser device itself, and perhaps an optical expansion system associated with it, are exposed to the greatest radiation intensity in the laser module, and thus, if dirt particles are present, they may be impaired to the greatest extent by the abovementioned laser-assisted deposition, the radiation intensity of the laser radiation in the range of a combustion chamber window that borders the laser module, for instance, on the combustion chamber of an internal combustion engine, is clearly less, so that the combustion chamber window is clearly less subject to the laser-assisted deposition.

As a result, according to the present invention, advantageously a first sealing region is provided which, for example, is formed by the housing of the laser module that is also present meanwhile. For all the optical components of the laser module which are only exposed to a relatively low radiation intensity, if only because of their positioning in the first sealing region, there comes about a sufficient protective effect from fouling.

For the laser device itself, that is particularly prone to fouling based on the high radiation intensity, its own, secondary sealing region is advantageously provided, which preferably lies completely within the primary sealing region. With that, the laser device is at once doubly protected from fouling.

What is particularly advantageous is that, because of this configuration, according to the present invention, the housing of the laser module, that implements the primary sealing region, does not have to be sealed hermetically as in systems up to now, that is, the best possible against outer influences, such as the input of dirt particles, but may be developed to have a constructively less costly seal, which is sufficient for protecting the combustion chamber window and other components which are only exposed to a comparatively low radiation intensity.

The secondary sealing region, that is preferably to be sealed a little better, also does not have to be sealed using the expenditure known from current systems, because it is already extensively protected by the primary sealing region, and also because lower temperatures and pressure values are present, in the primary sealing region, than at the outer surface of the housing of the laser module.

According to one advantageous variant of the present invention, the primary sealing region and the secondary sealing region may demonstrate a different seal tightness, so that, besides an optimal protective action, economical manufacturing of the laser module is also possible. The primary sealing region may, for instance, have a helium tightness of approximately less than, or equal to 10̂−7 mbar*l/s, but preferably greater than about 10̂−10 mbar*l/s, while the secondary sealing region has a helium tightness of approximately less than, or equal to 10̂−10 mbar*l/s.

In addition to the laser device, in one further variant of the present invention, at least one optical system associated with the laser device may be situated within the secondary sealing region, particularly an optical expansion system which expands laser pulses generated by the laser device, or their ray path.

In another advantageous variant of the present invention, the secondary sealing region may be formed by an inner space of a secondary housing, which is situated at least partially, but preferably totally, within the housing of the laser module.

The secondary housing may have a base shape that is essentially hollow cylindrical, which especially, at least at one end face, has a region that is optically transparent to the wavelength of the laser pulses generated and/or to the pumping light supplied to the laser device, preferably in the form of one or more windows. The optically transparent region may also be developed as a ray-imaging optical system, which forms the pumping light.

Furthermore, the secondary housing may be made advantageously at least partially of glass and/or metal, the metal being selected so that it has a coefficient of thermal expansion that is comparable to the coefficient of thermal expansion of the glass material used, so that no openings come about at the joints between the materials.

A particularly good protection of the optical component situated in the secondary sealing region comes about if the secondary sealing region is evacuated or has a specifiable atmosphere, particularly of an inert gas under a specifiable pressure, or the like.

A very economical construction of the laser module, according to the present invention, may generally be achieved by selecting the respective seal tightness of the sealing regions as a function of a radiation intensity that occurs during the operation of the laser module in the sealing regions, so that only the most sensitive components and the components that are exposed to the greatest extent to fouling, have to be encapsulated comparatively well by the secondary sealing region, while a lesser sealing effort is sufficient for the additional components.

The laser module according to the present invention may advantageously be used in laser-based ignition devices of the internal combustion engines of motor vehicles, and/or stationary engines or turbines, and preferably in all operating environments in which the usual laser modules have only an insufficient service life, based on their susceptibility to fouling.

### BRIEF DESCRIPTION OF THE SEVERAL VIEWS OF THE DRAWING

FIG. 1a shows a first example embodiment of the laser module according to the present invention.

FIG. 1b shows a second example of the laser module according to the present invention.

FIG. 2 shows a third example embodiment of the laser module according to the present invention.

### DETAILED DESCRIPTION OF THE INVENTION

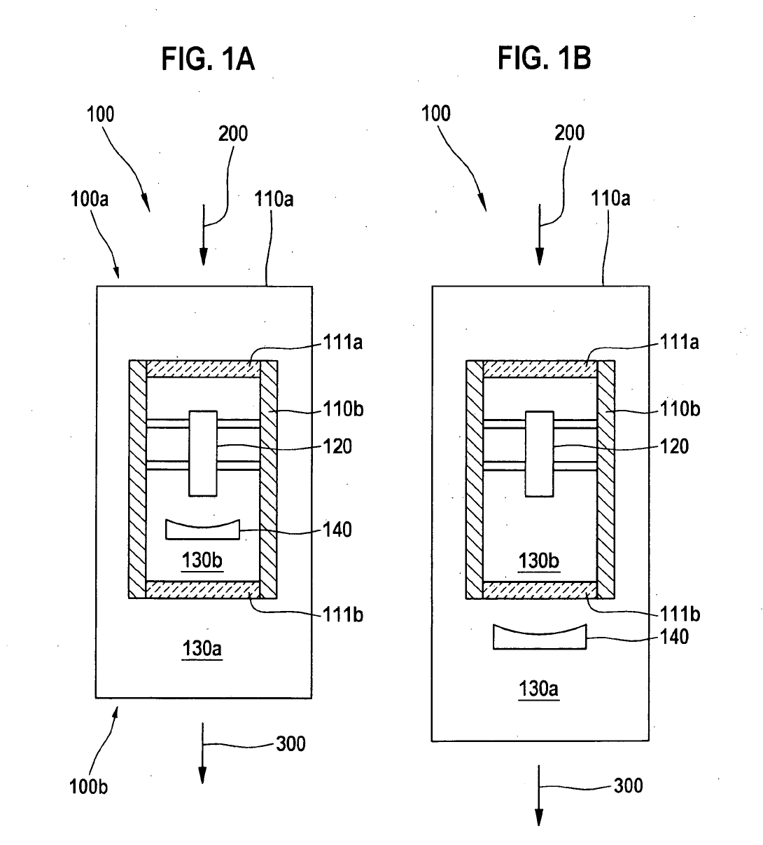

FIG. 1a shows a first example embodiment of laser module 100 according to the present invention. Laser module 100 has a primary sealing region 130a, which has a specifiable sealing effect with respect to the surroundings, and thereby prevents the penetration of particles from the surroundings into the inside of laser module 100.

In the present case, primary sealing region 130a is implemented by a primary housing 110a, which preferably surrounds the additional components of the laser module on all sides, according to the present invention. In a first end region 100a, primary housing 110a has an optically transparent region to enable the irradiation of pumping light 200 into primary sealing region 130a. Pumping light 200 is primarily needed for the optical pumping of a solid laser of laser device 120 that is, for example, passively Q-switched, and is included in laser module 100, and which generates laser pulses while being acted upon by pumping light 200, that is symbolized in FIG. 1a by arrow 300.

Primary housing 110a correspondingly also has an optically transparent region in second end region 100b, which makes possible coupling laser pulses 300 out of laser module 100.

The optically transparent regions described above and not illustrated in detail are formed, for example, by laser windows having plane-parallel surfaces or perhaps by focusing optical systems, or a combination of these. In the case of the use of laser module 100, illustrated in FIG. 1a, in an ignition device of a motor vehicle, especially a combustion chamber window, or even a so-called lens window, may be provided in second end region 100b, which makes possible the irradiation and/or focusing of laser pulse 300 into a combustion chamber of the internal combustion engine.

According to the present invention, in addition to the abovementioned primary housing 110a, which forms primary sealing region 130a, another, secondary sealing region 130b is provided. In the case at hand, secondary sealing region 130b is formed by a separate, secondary housing 110b, which is situated completely within primary sealing region 130a, as illustrated in FIG. 1a. That is why, according to the present invention, secondary housing 110b is advantageously exposed to less fouling in comparison to primary housing 110a, namely, only that particle action which originates with the particles that have already reached the inside of primary sealing region 130a.

What is particularly advantageous is that, because of this configuration, according to the present invention, housing 110a of laser module 100, that implements primary sealing region 130a, does not have to be sealed hermetically as in the systems up to now, that is, in the best manner possible against outer influences, such as the input of dirt particles, but may be developed to have a constructively less costly seal, which is sufficient for protecting the combustion chamber window and other components which are only exposed to a comparatively low radiation intensity.

Secondary sealing region 130b, that is preferably to be sealed a little better, also does not have to be sealed using the expenditure known from current systems, because it is already extensively protected by primary sealing region 130a, and also because lower temperatures and pressure values are present, in primary sealing region 130a, than at the outer surface of primary housing 110a of laser module 100.

According to one advantageous variant of the present invention, primary sealing region 130a and secondary sealing region 130b may demonstrate a different seal tightness, so that, besides an optimal protective action, economical manufacturing of laser module 100 is also possible. Primary sealing region 130a may, for instance, have a helium tightness of approximately less than, or equal to 10̂−4 mbar*l/s, but preferably greater than about 10̂−10 mbar*l/s, while the secondary sealing region has a helium tightness of approximately less than, or equal to 10̂−7 mbar*l/s.

In one additional advantageous variant of the present invention, in addition to laser device 120, at least one optical system 140 assigned to laser device 120 may be situated inside secondary sealing region 130b, as illustrated in FIG. 1a. In the case at hand, an optical expansion system 140 is involved which expands laser pulses 300, or their ray path, that are generated by laser device 120, and that are accordingly still exposed to a comparatively high radiation intensity.

As illustrated, secondary housing 110b may have an essentially hollow cylindrical base shape which has, in this instance, optically transparent regions at its end face, developed as laser windows 111a, 111b, in order to make possible the transmission of pumping light 200 to laser device 120 and of laser pulses 300 out of secondary housing 110b.

Alternatively or in addition, respective transparent region 111a, 111b may also be developed as a ray-imaging optical system, for instance, to form the irradiated pumping light onto laser device 120, and thus to make possible an optimization of the pumped mode volume.

Secondary housing 110b may be made of various materials, according to the present invention, which permit the development of a sealing housing 110b, that is resistant to temperature and/or pressure at the same time, for the planned field of use of laser module 100. Metal and/or glass are preferably used for the hollow cylindrical base element, that is not designated in greater detail, and special laser glass for laser windows 111a, 111b, the metal being selected so that it has a coefficient of thermal expansion that is comparable to the coefficient of thermal expansion of the glass material used, so that no openings come about that would impair the sealing action at the joints between the materials. In particular, one may use a metallic material according to DIN 17745, for instance, material No. 1.3981, 1.3922, 1.3920.

As the joining mechanism between the glass and the metal, especially soldering and/or adhesion and/or welding may be considered.

In the development of secondary housing 110b, one may advantageously fall back upon existing technologies and manufacturing methods, such as from the field of vacuum or tube technology. As is indicated in FIG. 1a, the mounting support of optical components 120, 140 in secondary housing 110b may take place by mounting elements, not designated in greater detail, which are developed, for example, as usual glass or metal lead-throughs, or even as form-locking metal mounting supports.

A particularly good protection of optical component 120, 140, situated in secondary sealing region 130b, comes about if secondary sealing region 130b is evacuated or has a specifiable atmosphere, particularly of an inert gas under a specifiable pressure, or the like, which is to be produced under appropriate clean room conditions.

In general, a very economical construction of laser module 100 may be achieved by selecting the respective seal tightness of sealing regions 130a, 130b as a function of a radiation intensity that occurs during the operation of laser module 100 in sealing regions 130a, 130b.

All in all, one may implement, in this manner, an improved protection of the optical elements, using a far lower construction expenditure than in the usual laser modules, particularly protection of the surfaces of laser device 120 which, in the present case, is doubly protected by the two cascaded sealing regions 130a, 130b from fouling.

At the same time, those optical surfaces as, for instance, the surface of a combustion chamber window (not shown) in end region 100b which, in comparison to laser device 120, are only exposed to a comparatively low laser radiation, are nevertheless effectively protected by primary housing 110a which, however, particularly does not have to be hermetically sealed, as is the case in the related art.

FIG. 1b shows another example embodiment of laser module 100 according to the present invention, in which only laser device 120 is situated within secondary sealing region 130b. Optical expansion system 140, assigned to it, is situated in primary sealing region 130a.

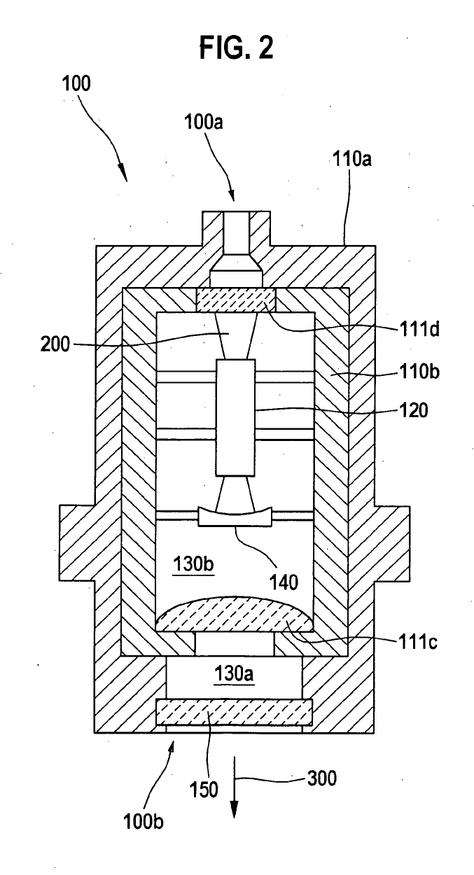

FIG. 2 shows an additional example embodiment of laser module 100 according to the present invention, in which secondary housing 110b, implementing secondary sealing region 130b, is connected to the greatest extent to primary housing 110a, so that there comes about a comparatively small primary sealing region 130a which, in the present case, is situated between a combustion chamber window 150 and a second end region of secondary housing 110b.

At its second end region, secondary housing 110b, according to FIG. 2, has a focusing optical system 111c, which at the same time seals secondary housing 110b at its end face, and bundles laser pulses 300, that are generated by laser device 120, all the way through combustion chamber window 150 to form a focal point (not shown) that is outside laser module 100.

At its first end region 100a, primary housing 110a has a passage for an optical guide device (not shown) which supplies laser device 120 with pumping light 200, all the way through laser window 111d. In this region, secondary housing 110b is accordingly not protected by primary housing 110a. This means that, in contrast to the specific embodiments of the present invention described, while referring to FIGS. 1a, 1b, in laser module 100 according to FIG. 2, secondary sealing region 130b, or rather secondary housing 110b implementing secondary sealing region 130b, is not completely integrated in primary housing 110a. Nevertheless, an improved protective effect of the optical components from fouling comes about, even in the variant of the present invention according to FIG. 2.

1-13. (canceled)

14. A laser module, comprising:
a primary housing; and
at least one laser device situated in the primary housing for generating laser pulses;
wherein the laser module has at least one primary sealing region and one secondary sealing region at least partially situated within the primary sealing region, and wherein the laser device is situated within the secondary sealing region.

15. The laser module as recited in claim 14, wherein the primary sealing region and the secondary sealing region have different seal tightness.

16. The laser module as recited in claim 15, wherein the primary sealing region has a helium tightness of less than 10̂−4 mbar*l/s and greater than 10̂−10 mbar*l/s.

17. The laser module as recited in claim 16, wherein the secondary sealing region has a helium tightness less than 10̂−7 mbar*l/s.

18. The laser module as recited in claim 17, wherein only the laser device is situated within the secondary sealing region.

19. The laser module as recited in claim 14, further comprising:
at least one optical expansion system assigned to the laser device and situated within the secondary sealing region, wherein the optical expansion system is configured to expand one of laser pulses generated by the laser device or the ray paths of the laser pulses.

20. The laser module as recited in claim 15, wherein the secondary sealing region is formed by an inner space of a secondary housing situated within the primary housing of the laser module.

21. The laser module as recited in claim 20, wherein the secondary housing includes a base element having a substantially hollow cylindrical form and having at one end face a region which is optically transparent to the wavelengths of at least one of the laser pulses generated by the laser device and the pumping light supplied to the laser device.

22. The laser module as recited in claim 21, wherein the optically transparent region is configured as a ray-imaging optical system.

23. The laser module as recited in claim 21, wherein the secondary housing is at least partially made of at least one of glass and metal, the metal having a coefficient of thermal expansion substantially corresponding to the coefficient of thermal expansion of the glass.

24. The laser module as recited in claim 21, wherein the secondary sealing region is one of evacuated or is filled with an inert gas under specified pressure.

25. The laser module as recited in claim 21, wherein the respective seal tightness of the first and second sealing regions is selected as a function of a radiation intensity occurring during the operation of the laser module in the sealing regions.

26. The laser module as recited in claim 21, wherein the laser module is for use as part of an ignition device.
